(19) United States
(12) Patent Application Publication
(10) Pub. No.: US 2002/0070550 A1
(43) Pub. Date: Jun. 13, 2002

(54) Rotation connector

(76) Inventors: Michael Lin, Chang Hua Hsien (TW); Joanna Jiang, Chang Hua Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/733,976

(22) Filed: Dec. 12, 2000

(51) Int. Cl. F16L 37/00

(52) U.S. Cl. 285/305

(57) ABSTRACT

A rotation connector includes a first connecting member provided with a female joint section defining an insertion recess and a ball locking groove, a second connecting member provided with a male joint section rotatably secured in the insertion recess and defining a ball receiving groove aligning with the ball locking groove, a plurality of rolling balls each mounted in the ball locking groove, and an elastic cushion secured in the ball receiving groove and urged on the rolling balls.

### BACKGROUND OF THE INVENTION

1. Field of the Invention

The present invention relates to a rotation connector.

2. Description of the Related Art

A first conventional rotation connector in accordance with the prior art shown in FIG. 1 comprises a first connecting member 10 which can be screwed in a tool such as a pneumatic tool, and a second connecting member 13 which can be fitted in a quick connector of a air pipe. The second connecting member 13 is rotatably mounted in the first connecting member 10, and a sealing ring 11 is mounted therebetween. A plurality of balls 12 are extended through a hole 101 defined in the first connecting member 10, and are received in a recess 131 defined in the second connecting member 13 by a cover 102. However, when the second connecting member 13 is pulled to move outward relative to the first connecting 10, the cover 102 is subjected to a pressure from the balls 101 so that the cover 102 is easily detached from the hole 101 of the first connecting 10 during long-term utilization.

A second conventional rotation connector in accordance with the prior art shown in FIG. 2 comprises a first connecting member 20 which can be screwed in a tool such as a pneumatic tool, and a second connecting member 25 which can be fitted in a quick connector of a air pipe. The first connecting member 20 is connected with the second connecting member 25 by riveting so that the second connecting member 25 can be rotatably mounted in the first connecting member 20 by a plurality of balls 23 which are limited by the rivet end of the first connecting member 20. However, the first connecting member 20 cannot be processed by a heating treatment for facilitating the rivet end 21 being easily punched to enclose the balls 23 so that the first connecting member 20 is not very stiff. In such a manner, the first connecting member 20 is easily worn out by the balls 23 during long-term utilization.

A third conventional rotation connector in accordance with the prior art shown in FIG. 3 has a structure the same as that as shown in FIG. 2, and is further provided with a ring 30 with a high stiffness 30. However, the rivet end 32 of the first connecting member 31 may be easily flattened during long-term utilization so that the first connecting member 31 is easily detached from the second connecting member 33.

### SUMMARY OF THE INVENTION

In accordance with one aspect of the present invention, there is provided a rotation connector comprising:

a first connecting member provided with a female joint section defining an insertion recess therein, the insertion recess having a wall defining a ball locking groove;

a second connecting member rotatably connected with the first connecting member and provided with a male joint section rotatably secured in the insertion recess of the first connecting member, the male joint section of the second connecting member having an outer wall defining a ball receiving groove aligning with the ball locking groove of the insertion recess of the first connecting member;

a plurality of rolling balls each mounted in the ball locking groove of the insertion recess of the first connecting member; and

an elastic cushion secured in the ball receiving groove of the second connecting member and urged on the rolling balls.

Further benefits and advantages of the present invention will become apparent after a careful reading of the detailed description with appropriate reference to the accompanying drawings.

### BRIEF DESCRIPTION OF THE DRAWINGS

FIG. 1 is a front cross-sectional assembly view of a first conventional rotation connector in accordance with the prior art;

FIG. 2 is a front cross-sectional assembly view of a first conventional rotation connector in accordance with the prior art;

FIG. 3 is a front cross-sectional assembly view of a first conventional rotation connector in accordance with the prior art;

FIG. 4 is an exploded view of a rotation connector in accordance with a first embodiment of the present invention;

FIG. 5 is a front plan cross-sectional assembly view of the rotation connector as shown in FIG. 4;

FIG. 6A is a cross-sectional view showing the assembly of the rotation connector as shown in FIG. 4;

FIG. 6B is an operational view of the rotation connector as shown in FIG. 6A;

FIG. 7 is an operational view of the rotation connector as shown in FIG. 5;

FIG. 8 is an exploded view of a rotation connector in accordance with a second embodiment of the present invention;

FIG. 9 is a front plan cross-sectional assembly view of the rotation connector as shown in FIG. 8; and

FIG. 10 is a cross-sectional assembly view showing the rotation connector being used for a hanging hook device.

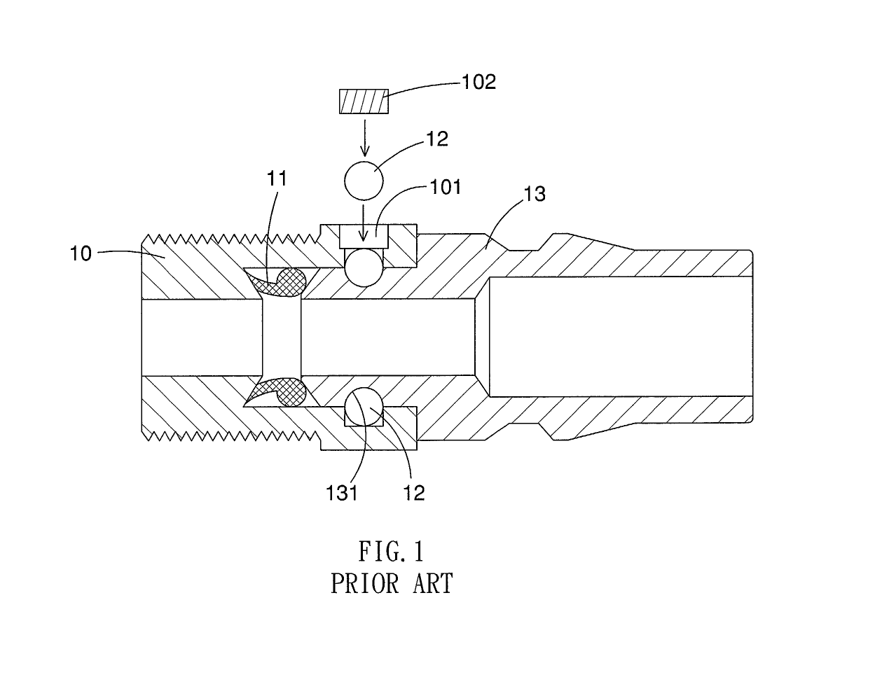

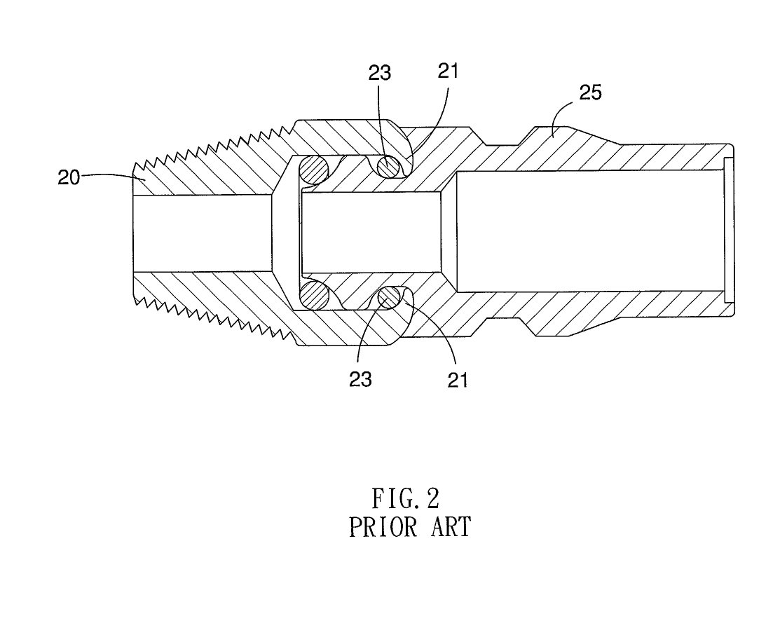

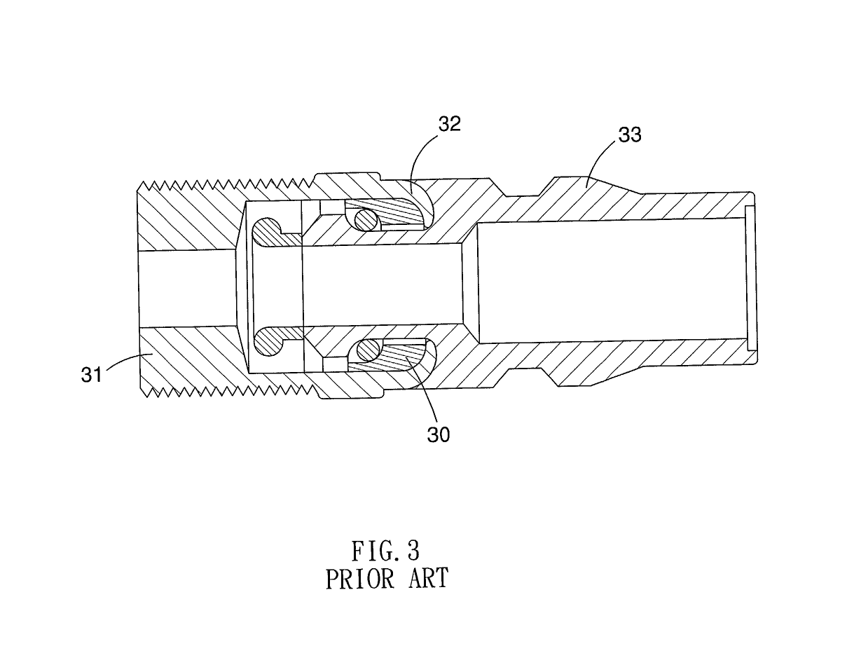

### DETAILED DESCRIPTION OF THE INVENTION

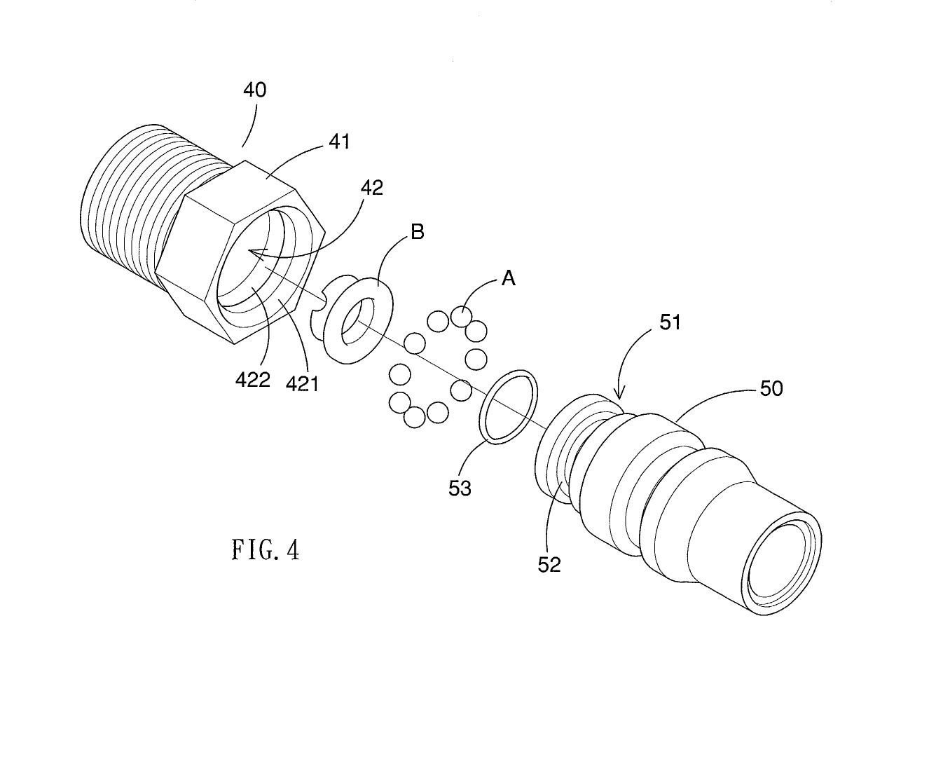

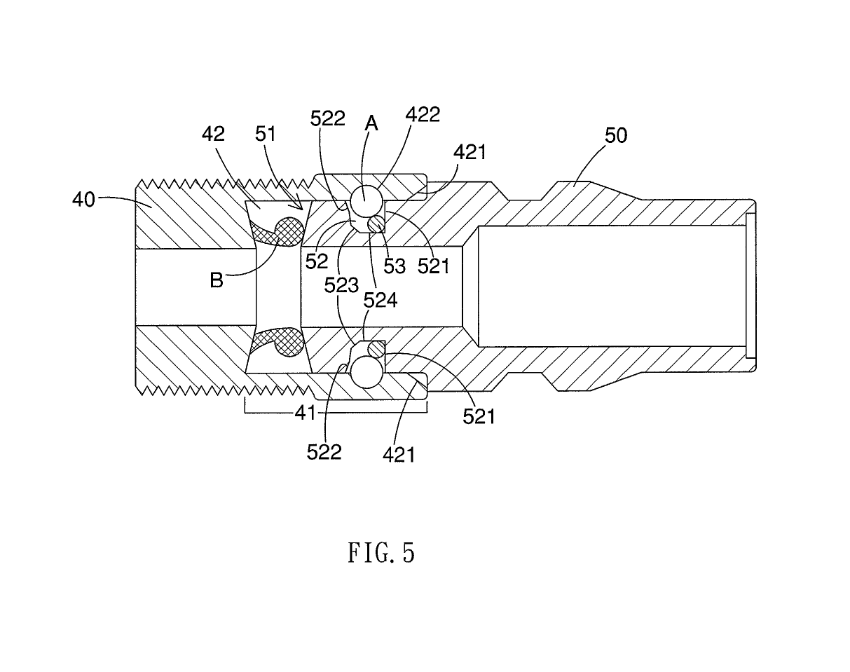

Referring to the drawings and initially to FIGS. 4 and 5, a rotation connector in accordance with a first embodiment of the present invention generally comprises a first connecting member 40 which can be screwed in a tool such as a pneumatic tool, and a second connecting member 50 which can be fitted in a quick connector of a air pipe.

The first connecting member 40 is a hollow conduit and is provided with a female joint section 41 defining an insertion recess 42 therein. The insertion recess 42 has a wall defining a ball locking groove 422.

The second connecting member 50 is rotatably connected with the first connecting member 40 and is provided with a male joint section 51 rotatably secured in the insertion recess 42 of the first connecting member 40. Preferably, the second connecting member 50 is a hollow conduit. The male joint section 51 of the second connecting member 50 has an outer wall defining a ball receiving groove 52 aligning with the ball locking groove 422 of the insertion recess 42 of the first connecting member 40.

Preferably, the ball locking groove 422 of the insertion recess 42 of the first connecting member 40 and the ball receiving groove 52 of the second connecting member 50 are annular grooves.

A plurality of rolling balls “A” are each mounted in the ball locking groove 422 of the insertion recess 42 of the first connecting member 40. An elastic cushion 53 is secured in the ball receiving groove 52 of the second connecting member 50 and is urged on the rolling balls “A”. Preferably, the elastic cushion 53 is an elastic O-ring. A sealing washer “B” is mounted in the insertion recess 42 of the first connecting member 40 and is urged on the male joint section 51 of the second connecting member 50.

The ball receiving groove 52 of the second connecting member 50 has a first side wall provided with a vertical face 521 urged on the rolling balls “A” and the elastic cushion 53, a second side wall provided with an inclined face 522 facing the rolling balls “A” for urging the rolling balls “A”, and a bottom wall provided with a flat face 524 on which the elastic cushion 53 is secured. Preferably, the bottom wall of the ball receiving groove 52 of the second connecting member 50 is provided with an inclined positioning face 523 located adjacent to the flat face 524 for limiting further movement of the elastic cushion 53.

The insertion recess 42 of the first connecting member 40 has a distal end provided with an inclined guide face 421 for facilitating insertion of the male joint section 51 of the second connecting member 50.

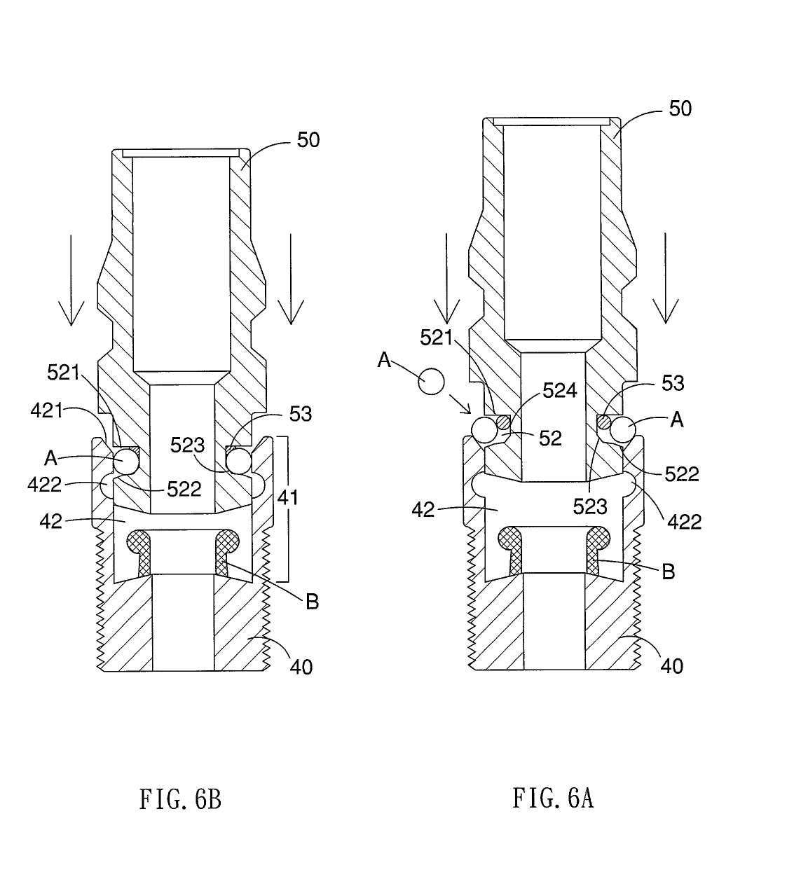

In assembly, referring to FIGS. 4-7, the elastic cushion 53 is initially secured in the ball receiving groove 52 of the second connecting member 50 and is fitted on the flat face 524 while the rolling balls “A” are inserted into the ball receiving groove 52 of the second connecting member 50 and are rested on the inclined guide face 421 of the insertion recess 42 of the first connecting member 40 as shown in FIG. 6A.

The male joint section 51 of the second connecting member 50 is then pressed toward the female joint section 41 of the first connecting member 40 to move from the position as shown in FIG. 6A to the position as shown in FIG. 6B, thereby forcing the rolling balls “A” to be inserted into the insertion recess 42 of the first connecting member 40 through the inclined guide face 421 while the elastic cushion 53 is compressed and distorted by the rolling balls “A” as shown in FIG. 6B.

When the male joint section 51 of the second connecting member 50 is further moved from the position as shown in FIG. 6B to the position as shown in FIG. 5, the ball receiving groove 52 aligns with the ball locking groove 422 so that the rolling balls “A” are forced to be inserted into the ball locking groove 422 of the insertion recess 42 of the first connecting member 40 by the restoring force of the elastic cushion 53 whereby the rolling balls “A” are securely locked in the ball locking groove 422 by the elastic cushion 53 as shown in FIG. 5.

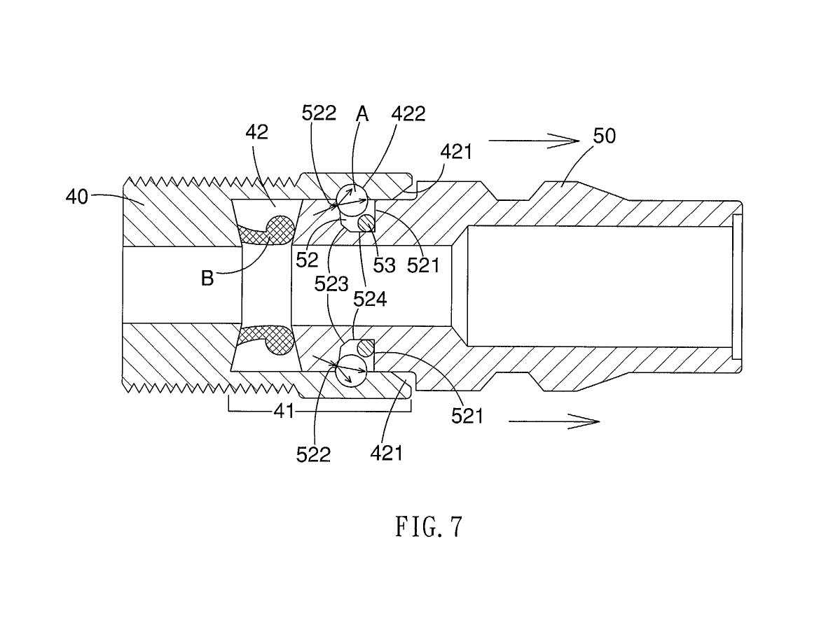

As shown in FIG. 7, when the male joint section 51 of the second connecting member 50 is subjected to a pulling force to move outward relative to the female joint section 41 of the first connecting member 40, the inclined face 522 of the ball receiving groove 52 of the second connecting member 50 is moved to press and urge the rolling balls “A” in an oblique manner so that the rolling balls “A” are securely locked in the ball locking groove 422 by the inclined face 522 without the possibility of retracting into the ball receiving groove 52 of the second connecting member 50 so that the first connecting member 40 and the second connecting member 50 are securely coupled with each other, and cannot be detached by an external force.

Accordingly, the rotation connector of the present invention has a simple construction, and can be assembled quickly and easily. In addition, the first connecting member and the second connecting member processed by a heat treatment have a high stiffness so that they are not easily worn out during long-term utilization, thereby increasing the lifetime of the rotation connector. Further, the first connecting member and the second connecting member are securely coupled with each other without the possibility of detachment during long-term utilization, thereby enhancing the efficiency and versatility of the rotation connector. Further, the rolling balls are rigidly and stably locked in the ball locking groove without having to additionally provide a sealing cover, thereby decreasing the cost of fabrication.

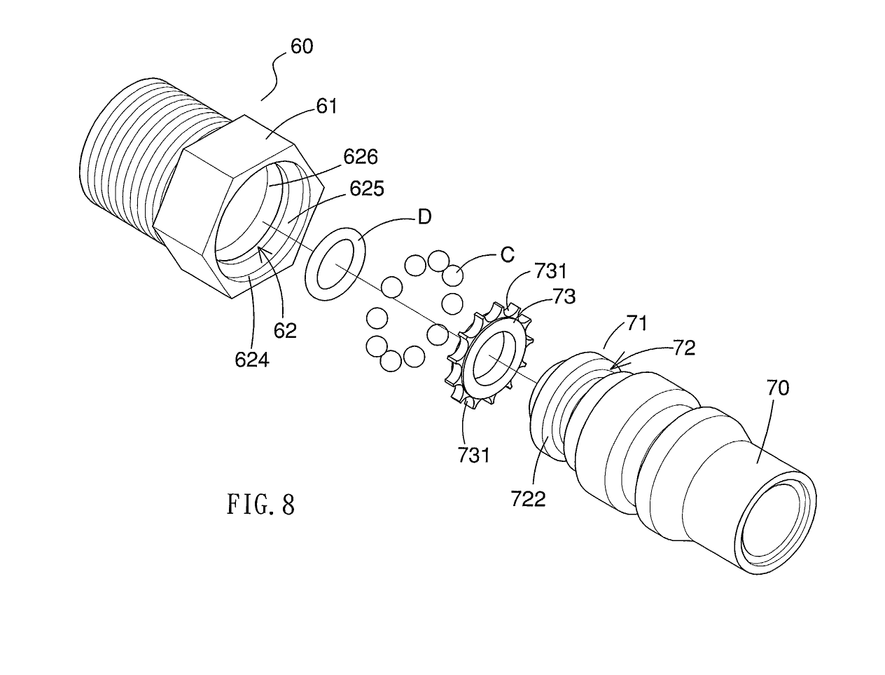

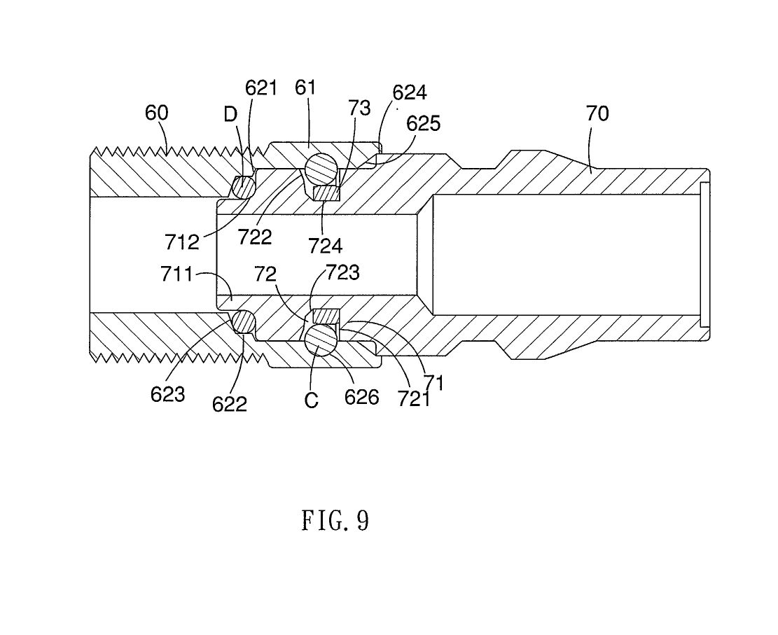

Referring to FIGS. 8 and 9, in accordance with a second embodiment of the present invention, the first connecting member 60 is also provided with a female joint section 61 defining an insertion recess 62 therein. The insertion recess 62 has a wall defining a ball locking groove 626. The second connecting member 70 is also provided with a male joint section 71 having an outer wall defining a ball receiving groove 72. The ball receiving groove 72 of the second connecting member 70 has a first side wall provided with a vertical face 721 urged on the rolling balls “C” and the elastic cushion 73, a second side wall provided with an inclined face 722 facing the rolling balls “C”, and a bottom wall provided with a flat face 724 and an inclined positioning face 723 located adjacent to the flat face 724 for limiting further movement of the elastic cushion 73.

The elastic cushion 73 is an elastic O-ring having an outer periphery defining a plurality of arcuate recesses 731 for receiving the rolling balls “C” therein. The insertion recess 62 of the first connecting member 60 has a distal end provided with an inclined guide face 625 for facilitating insertion of the male joint section 71 of the second connecting member 70, and a flat portion 624 located adjacent to the inclined guide face 625.

The sealing washer “D” is an O-ring. The male joint section 71 of the second connecting member 70 is provided with a flange 711 defining an arcuate face 712 on which the sealing washer D is rested. The insertion recess 62 of the first connecting member 60 is provided with a first inclined face 621 rested on the flange 711 of the male joint section 71 of the second connecting member 70, a flat face 622 located adjacent to the first inclined face 621 and rested on the sealing washer D, and a second inclined face 623 located adjacent to the flat face 622 and urged on the sealing washer D.

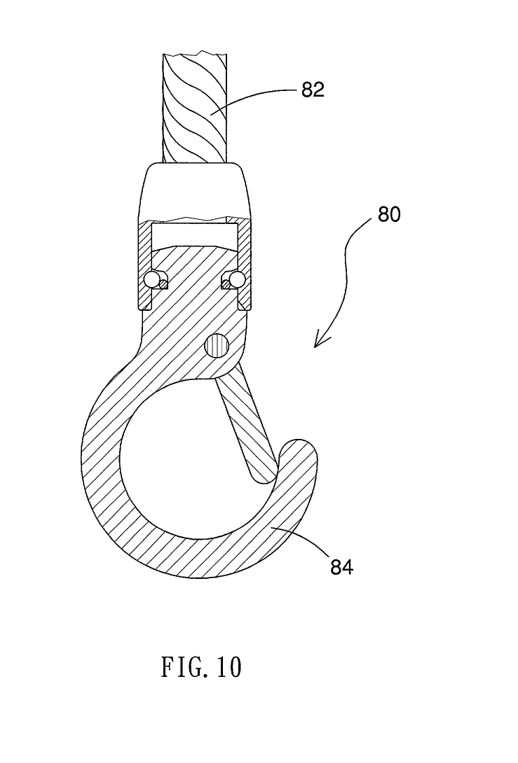

Referring to FIG. 10, the rotation connector of the present invention is used for a hanging hook device 80 whereby the cable 82 is not rotated with the hook 84.

It should be clear to those skilled in the art that further embodiments may be made without departing from the scope of the present invention.

What is claimed is:

1. A rotation connector comprising:
a first connecting member provided with a female joint section defining an insertion recess therein, the insertion recess having a wall defining a ball locking groove;
a second connecting member rotatably connected with the first connecting member and provided with a male joint section rotatably secured in the insertion recess of the first connecting member, the male joint section of the second connecting member having an outer wall defining a ball receiving groove aligning with the ball locking groove of the insertion recess of the first connecting member;
a plurality of rolling balls each mounted in the ball locking groove of the insertion recess of the first connecting member; and
an elastic cushion secured in the ball receiving groove of the second connecting member and urged on the rolling balls.

2. The rotation connector in accordance with claim 1, wherein the ball receiving groove of the second connecting member has a first side wall provided with a vertical face urged on the rolling balls and the elastic cushion, a second side wall provided with an inclined face facing the rolling balls, and a bottom wall provided with a flat face on which the elastic cushion is secured.

3. The rotation connector in accordance with claim 2, wherein the bottom wall of the ball receiving groove of the second connecting member is provided with an inclined positioning face located adjacent to the flat face for limiting further movement of the elastic cushion.

4. The rotation connector in accordance with claim 1, wherein the insertion recess of the first connecting member has a distal end provided with an inclined guide face for facilitating insertion of the male joint section of the second connecting member.

5. The rotation connector in accordance with claim 1, further comprising a sealing washer mounted in the insertion recess of the first connecting member and urged on the male joint section of the second connecting member.

6. The rotation connector in accordance with claim 1, wherein the ball locking groove of the insertion recess of the first connecting member and the ball receiving groove of the second connecting member are annular grooves.

7. The rotation connector in accordance with claim 1, wherein the elastic cushion is an elastic O-ring.

8. The rotation connector in accordance with claim 1, wherein the elastic cushion is an elastic O-ring having an outer periphery defining a plurality of arcuate recesses for receiving the rolling balls therein.

9. The rotation connector in accordance with claim 1, wherein the insertion recess of the first connecting member has a distal end provided with an inclined guide face for facilitating insertion of the male joint section of the second connecting member, and a flat portion located adjacent to the inclined guide face.

10. The rotation connector in accordance with claim 5, wherein the sealing washer is an O-ring, the male joint section of the second connecting member is provided with a flange defining an arcuate face on which the sealing washer is rested, and the insertion recess of the first connecting member is provided with a first inclined face rested on the flange of the male joint section of the second connecting member, a flat face located adjacent to the first inclined face and rested on the sealing washer, and a second inclined face located adjacent to the flat face and urged on the sealing washer.
